(19) United States
(12) Patent Application Publication
(10) Pub. No.: US 2013/0202234 A1
(43) Pub. Date: Aug. 8, 2013

(54) SLEWING BEARING STRUCTURE

(71) Applicants: Yoshitomo NODA, Tokyo (JP); Kensuke NISHIURA, Tokyo (JP); Tomohiro NUMAJIRI, Tokyo (JP)

(72) Inventors: Yoshitomo NODA, Tokyo (JP); Kensuke NISHIURA, Tokyo (JP); Tomohiro NUMAJIRI, Tokyo (JP)

(73) Assignee: MITSUBISHI HEAVY INDUSTRIES, LTD., Tokyo (JP)

(21) Appl. No.: 13/367,124

(22) Filed: Feb. 6, 2012

(51) Int. Cl. F16C 33/58; F16C 19/50

(52) U.S. Cl. 384/447; 384/490

(57) ABSTRACT

There is provided a slewing bearing structure capable of maintaining favorable bearing performance by adjusting and changing rigidity thereof while minimizing the increase in the weight thereof for preventing distortion of a pressure pattern caused by structural deformation from unfavorably affecting the bearing performance. A slewing bearing of a rolling bearing, in which a rolling element is put between bearing rings and formed on an inner ring and an outer ring, has a slewing bearing structure in which a rigidity strengthening portion, at which rigidity of the inner ring and/or the outer ring is increased more than that at peripheral portions, is formed at a circumferential area where a bearing contact pressure is high.

### BACKGROUND OF THE INVENTION

1. Field of the Invention

The present invention relates to a slewing bearing structure of a rolling bearing suitable for a yaw drive unit of a nacelle and a pitch drive unit of a wind turbine blade, for example.

2. Description of the Related Art

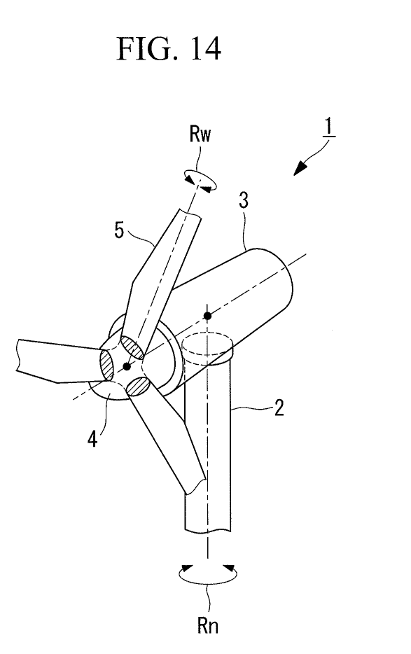

A wind turbine apparatus (hereinafter referred to as a wind turbine) 1 shown in FIG. 14 is an apparatus in which a rotor head 4 providing wind turbine blades 5 rotates by receiving wind and the speed of that rotation is increased by a gear box, for example, for driving a power generator to generate electricity.

In the wind turbine apparatus 1, since the rotor head 4 providing the wind turbine blades 5 is connected via a main axis with the gear box and the power generator in a nacelle 3 provided at a top of a tower 2, the orientation of the rotor head 4 needs to be aligned with an ever-changing wind direction (or a rotor rotational plane needs to directly face against the wind direction).

Thus, the up wind-type wind turbine apparatus 1 includes a yaw drive unit as an apparatus for slewing the nacelle 3 on the tower 2 in a yaw direction (or slewing on a substantially horizontal surface in a direction indicated by an arrow Rn) to receive wind on a front face of the rotor head 4, or slewing the nacelle 3 against the tower 2 in a yaw direction.

Also, since each of the wind turbine blades 5 needs to change the pitch angle thereof according to changes of wind speed or the like, a pitch drive unit is provided for each of the wind turbine blades 5 as an apparatus for slewing the wind turbine blade 5 against the rotor head 4 in a direction indicated by an arrow Rw.

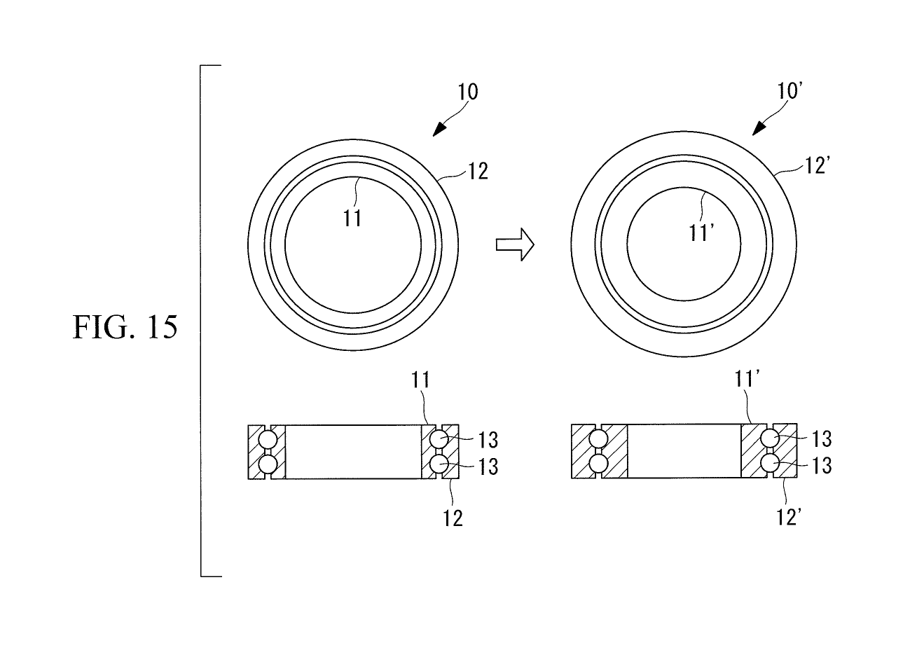

In the yaw drive unit and the pitch drive unit described above, a slewing bearing 10, configured as shown on the left side in FIG. 15, for example, is adopted as a wind turbine slewing bearing to slewably support each of the nacelle 3 and the wind turbine blade 5. The slewing bearing 10 is a rolling bearing having a configuration in which rolling elements 13 are disposed between an inner ring 11 and an outer ring 12, or a mechanical support element for allowing the inner ring 11 and the outer ring 12 to rotate relative to each other.

Also, the slewing bearing 10 for a wind turbine or the like is designed on the basis of a maximum contact pressure. Commonly used examples of the slewing bearing 10 including the wind turbine slewing bearing described above, especially a large slewing bearing such as the wind turbine slewing bearing, use the inner ring 11 and the outer ring 12 as a part of a strength member constituting a structure such as the tower 2, the nacelle 3, the rotor head 4 and the like in which the slewing bearing 10 is installed.

Thus, if the rigidity of the slewing bearing 10 is not enough, bearing performance also incurs adverse effects such as distortion of a pressure pattern caused by structural deformation of a surrounding area.

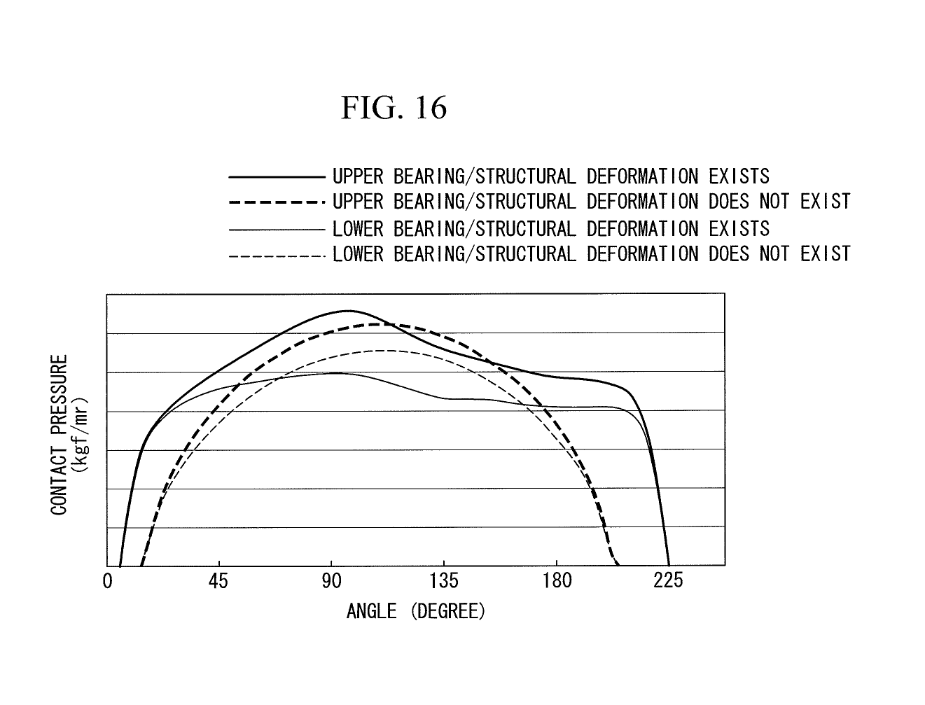

FIG. 16 shows, regarding a slewing bearing having two rows of rolling elements 13 in a vertical direction, a relationship between existence of structural deformation and a contact pressure. According to this figure, the pressure pattern without structural deformation is a substantially semicircular arc shape, but the shape becomes greatly distorted when structural deformation exists. The horizontal axis in FIG. 16 indicates an angle in a circumferential direction. In the following description, upper and lower rows of the rolling elements 13 correspond to a side of the nacelle 3 and a side of the tower 2, respectively, when the slewing bearing 10 is used for a yaw drive unit. And when the slewing bearing 10 is used for a pitch drive unit, the upper and lower rows of the rolling elements 13 correspond to a side of a distal end of the wind turbine blade 5 and a side of a root of the wind turbine blade 5 which is attached to the rotor head 4, respectively.

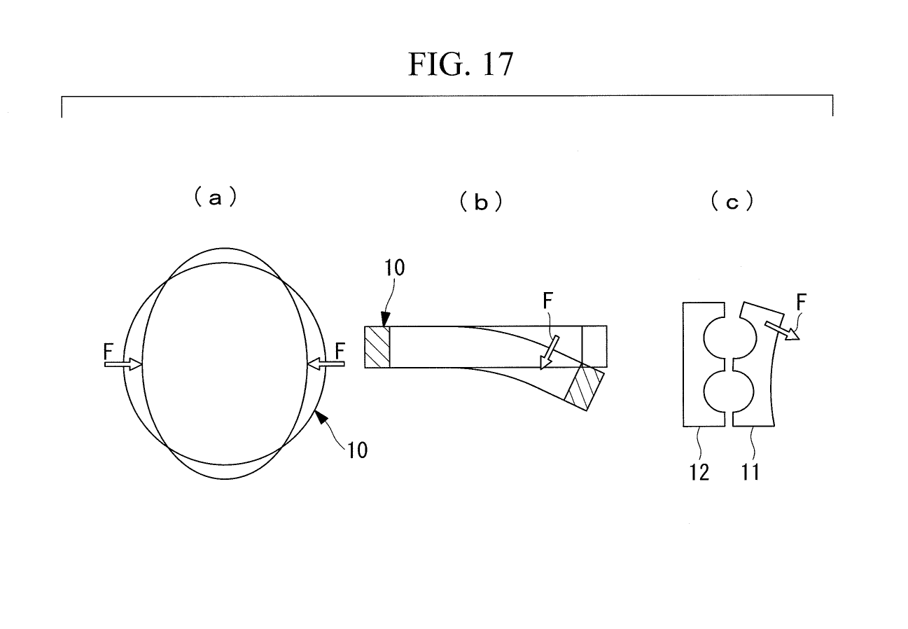

FIG. 17 shows examples of structural deformation when an external force is acting on the slewing bearing 10. Depending on the direction of an external force F shown by arrows in the figure, the inner ring 11 and the outer ring 12 deform differently.

FIG. 17(a) shows an example where an external force deforms the inner ring 11 and the outer ring 12 into an oval shape, FIG. 17(b) shows an example where an external force bends the inner ring 11 and the outer ring 12 in an axial direction, and FIG. 17(c) shows an example where an external force causes deformation in a direction where a space between the inner ring 11 and the outer ring 12 is broadened.

In relation to the slewing bearing (or rolling bearing) 10, an art is proposed, such as the one disclosed in Japanese Unexamined Patent Application, Publication No. 2010-23665, for increasing the number of fixing portions of the bearing to increase rigidity to prevent deformation caused by an outer force and maintain constancy of a contact pressure.

When the above-described slewing bearing 10 for a wind turbine or the like is subjected to a load and the inner ring 11 and the outer ring 12 deform under the effects of structural deformation of the periphery, a pressure pattern acting on the rolling element 13 is distorted and a part thereof may locally increase. For example, as shown in FIG. 16, comparing the pressure pattern of when structural deformation exists and the pressure pattern of when structural deformation does not exist, which is depicted as a substantially semicircular arc shape, for an upper bearing, which is one of the two rows of the rolling elements 13 in a vertical direction, the maximum value of the former at about 90 degrees is higher than the maximum value of the latter.

As a solution to eliminate such distortion of a pressure pattern, the physical size of an inner ring 11′ and an outer ring 12′ may be increased for ensuring enough rigidity, as with a slewing bearing 10′ shown on the right in FIG. 15. Unfortunately, in the case of the slewing bearing 10 used for a yaw drive unit and a pitch drive unit of the wind turbine apparatus 1, increasing the physical size is not preferable because that could increase the weight of the slewing bearing 10, which is a component provided at the top of the tower 2. Especially the wind turbine apparatus 1 is becoming larger in recent years for achieving greater output power, and saving the weight of the nacelle 3, the rotor head 4 or the like containing the slewing bearing 10 is becoming an important issue for alleviating a burden on the tower 2.

An object of the present invention, which has been accomplished to address the above problem, is to provide a slewing bearing structure capable of maintaining favorable bearing performance by adjusting and changing the rigidity of a bearing while minimizing the increase in weight so as to prevent distortion of a pressure pattern caused by structural deformation from unfavorably affecting the bearing performance.

### BRIEF SUMMARY OF THE INVENTION In order to address the above problem, the present invention adopted the following solutions.

A slewing bearing structure in accordance with a first aspect of the present invention is a slewing bearing structure of a rolling bearing in which a rolling element is put between bearing rings formed on an inner ring and an outer ring, wherein a rigidity strengthening portion, at which rigidity of the inner ring and/or the outer ring is increased more than that at peripheral portions, is formed at a circumferential area where a bearing contact pressure is high.

According to such slewing bearing structure, since a rigidity strengthening portion, at which the rigidity of the inner ring and/or the outer ring is increased more than that at peripheral portions, is provided at a circumferential area where a bearing contact pressure is high, distortion of a pressure pattern can be eliminated while minimizing the increase in weight by changing the rigidity of the inner ring and the outer ring in a circumferential direction in accordance with a contact pressure. That is, since the rigidity strengthening portion on the inner ring or the outer ring is a portion for partially increasing the rigidity at a circumferential area where a bearing contact pressure is high and deformation easily occurs, a circumferential area with enough rigidity does not have the rigidity strengthening area, which could cause the increase in weight, and it is thus possible to maintain bearing performance while suppressing the weight of the slewing bearing as a whole.

In the above-described slewing bearing structure, the rigidity strengthening portion is preferably a wide portion created by altering an inner diameter of the inner ring and/or an outer diameter of the outer ring in out-of-round fashion. That is, a wide portion of the inner ring is a rigidity strengthening portion where a width of the inner ring in a planar view is increased (or a cross-sectional area is increased) by decreasing an inner diameter of the inner ring, and a wide portion of the outer ring is a rigidity strengthening portion where a width of the outer ring in a planar view is increased (or a cross-sectional area is increased) by increasing an outer diameter of the outer ring.

The wide portion may have a trapezoidal cross-sectional shape in an axial direction. That is, if the cross-sectional shape of the wide portion is adapted to be trapezoidal where a side on an top surface which receives a bearing contact pressure is longer than a side on a bottom surface which is in parallel with the top surface, the rigidity (or cross-sectional area) of the inner ring or the outer ring can be increased while minimizing the increase in the weight thereof to eliminate distortion of a pressure pattern.

In the above slewing bearing structure, the rigidity strengthening portion may provide a reinforcing member attached to an outer periphery of the outer ring and/or an inner periphery of the inner ring. The rigidity of the inner ring or the outer ring of the reinforcing member may be altered in the circumferential direction in accordance with a bearing contact pressure, and it is thus possible to eliminate distortion of a pressure pattern while minimizing the increase in the weight of the inner ring or the outer ring.

As the above-described reinforcing member, a rib, a reinforcing plate, or the like may be provided on the outer periphery of the outer ring or the inner periphery of the inner ring. The reinforcing plate may have a cross-sectional shape where the thickness thereof changes in accordance a bearing contact pressure.

The above-described reinforcing member may be partially attached to an upper portion of the outer periphery of the outer ring and/or the inner periphery of the inner ring in a vertical direction for increasing the rigidity of the top surface which receives a bearing contact pressure.

A slewing bearing structure in accordance with a second aspect of the present invention is a slewing bearing structure of a rolling bearing in which a rolling element is put between bearing rings formed on an inner ring and an outer ring, wherein an initial contact angle, at which the rolling element contacts with a surface of the bearing rings under no load, is adapted to change in a circumferential direction so that a maximum contact pressure under weight load and structural deformation is decreased.

According to such slewing bearing structure, since the initial contact angle, at which the rolling element contacts with a surface of the bearing rings under no load, is adapted to change in a circumferential direction so that a maximum contact pressure under weight load and structural deformation is decreased, it is possible to avoid sudden increase of a contact pressure which happens when a contact angle is significantly shifted on receiving a load and a contact ellipse moves onto an edge portion. That is, since an initial contact angle, which used to be constant in a circumferential direction, is adapted to change in a circumferential direction so that the maximum contact pressure under weight load and structural deformation is decreased, the contact ellipse does not move onto an edge portion even under an operating load, and it is thus possible to suppress shifting of a contact angle to avoid sudden increase of the contact pressure.

A slewing bearing structure in accordance with a third aspect of the present invention is a slewing bearing structure of a rolling bearing in which a rolling element is put between bearing rings formed on an inner ring and an outer ring, wherein a groove radius of the bearing rings is adapted to change in a circumferential direction so that a maximum contact pressure under weight load and structural deformation is decreased.

According to such slewing bearing structure, since a groove radius of the bearing rings is adapted to change in a circumferential direction so that a maximum contact pressure under weight load and structural deformation is decreased, a contact pressure at a portion where the maximum contact pressure occurs can be suppressed while minimizing the increase in a bearing torque. That is, since the groove radius of the bearing rings, which used to be constant in a circumferential direction, is adapted to change in a circumferential direction so that the maximum contact pressure under weight load and structural deformation is decreased, a relation (or ratio) of a diameter of the rolling element and a groove radius of the bearing rings is optimized under operating load, enabling to suppress the maximum contact pressure and the bearing torque.

According to the above-described slewing bearing structures of the present invention, by adjusting and changing the rigidity of a bearing while minimizing the increase in weight, it is possible to prevent distortion of a pressure pattern caused by structural deformation from unfavorably affecting bearing performance to maintain favorable bearing performance.

Also, by altering and optimizing as needed an initial contact angle and a groove radius of a bearing ring in a circumferential direction, a sudden increase of a contact pressure can be avoided or a maximum contact pressure and a bearing torque can be suppressed.

BRIEF DESCRIPTION OF THE SEVERAL VIEWS OF THE DRAWINGS

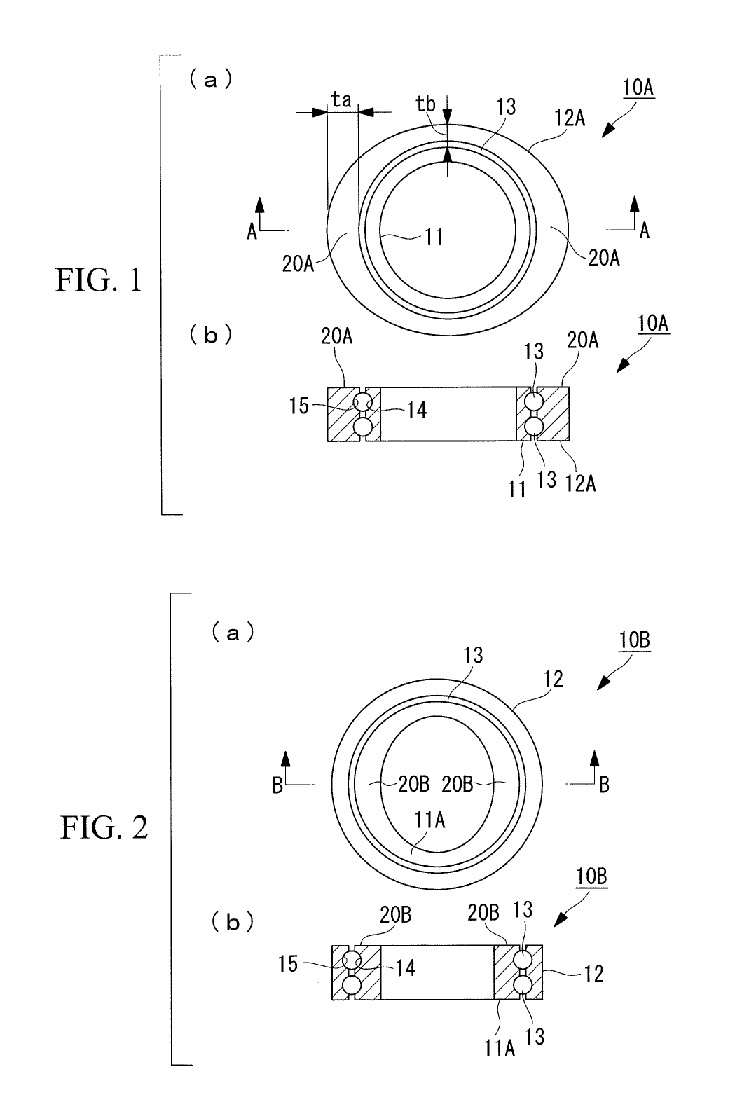

FIG. 1 is a diagram depicting a first embodiment of a slew ring bearing structure in accordance with the present invention, wherein (a) is a plane view and (b) is a cross-sectional view taken along line A-A of (a);

FIG. 2 is a diagram depicting a first modification of the slew ring bearing structure in accordance with the first embodiment, wherein (a) is a plane view and (b) is a cross-sectional view taken along line B-B of (a);

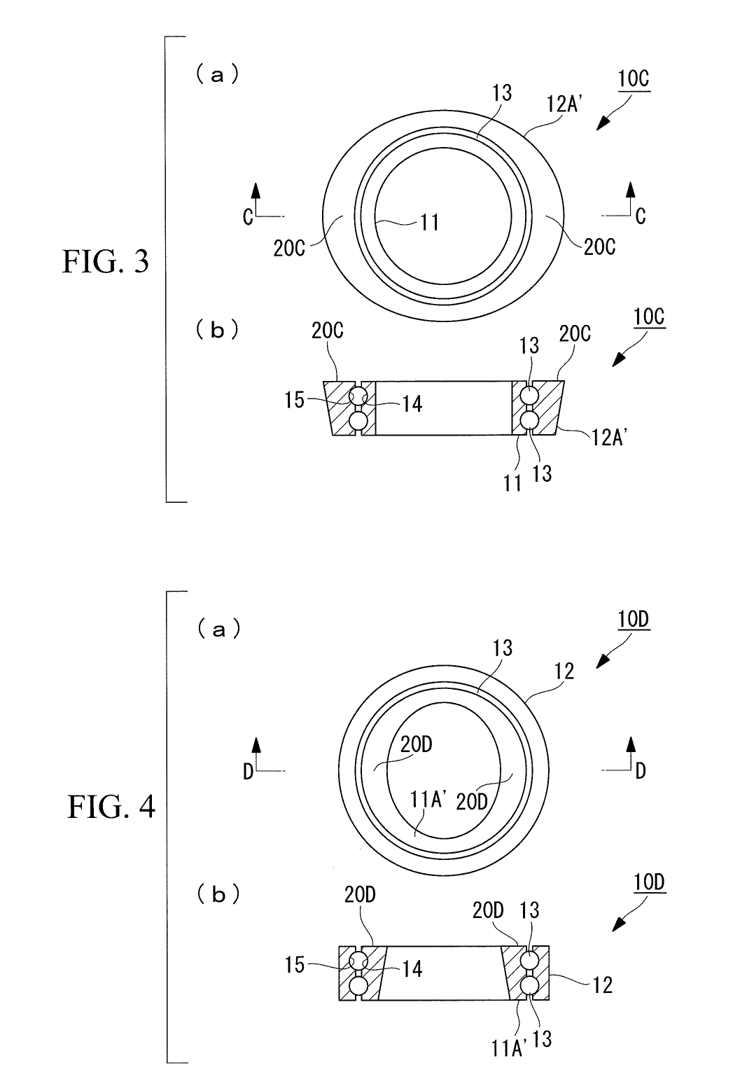

FIG. 3 is a diagram depicting a second modification of the slew ring bearing structure in accordance with the first embodiment, wherein (a) is a plane view and (b) is a cross-sectional view taken along line C-C of (a);

FIG. 4 is a diagram depicting a third modification of the slew ring bearing structure in accordance with the first embodiment, wherein (a) is a plane view and (b) is a cross-sectional view taken along line D-D of (a);

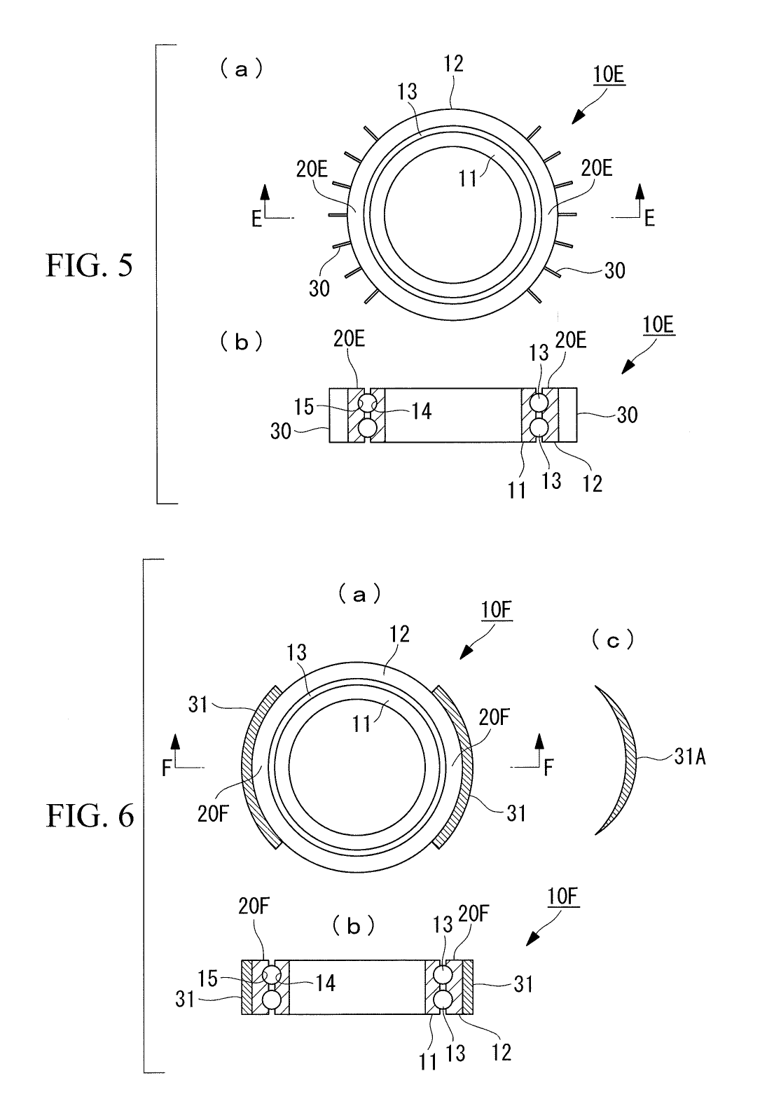

FIG. 5 is a diagram depicting a fourth modification of the slew ring bearing structure in accordance with the first embodiment, wherein (a) is a plane view and (b) is a cross-sectional view taken along line E-E of (a);

FIG. 6 is a diagram depicting a fifth modification of the slew ring bearing structure in accordance with the first embodiment, wherein (a) is a plane view, (b) is a cross-sectional view taken along line F-F of (a), and (c) depicts a first modification of a reinforcing member;

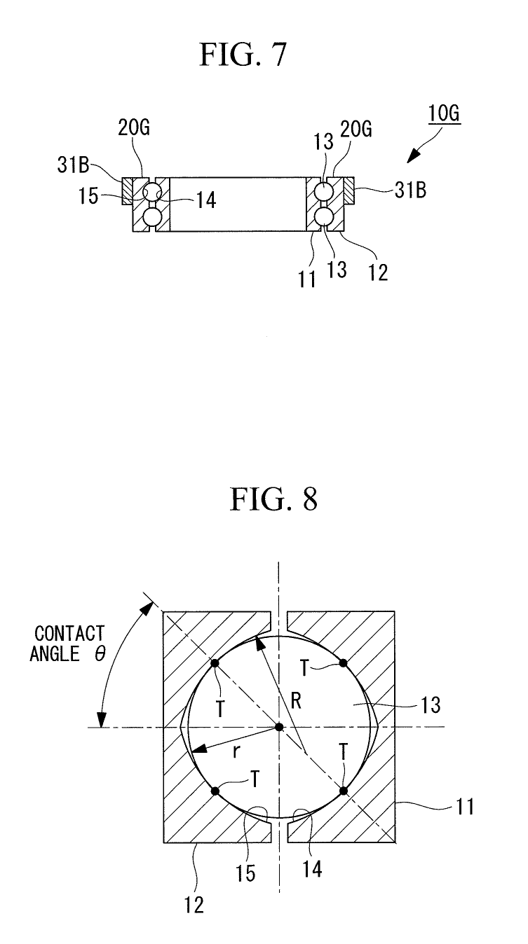

FIG. 7 is a cross-sectional view of the fifth modification of the slewing bearing structure shown in FIG. 6 where a second modification of the reinforcing member is attached;

FIG. 8 is a cross-sectional view for describing a normal state of a contact angle of a rolling element put between bearing rings;

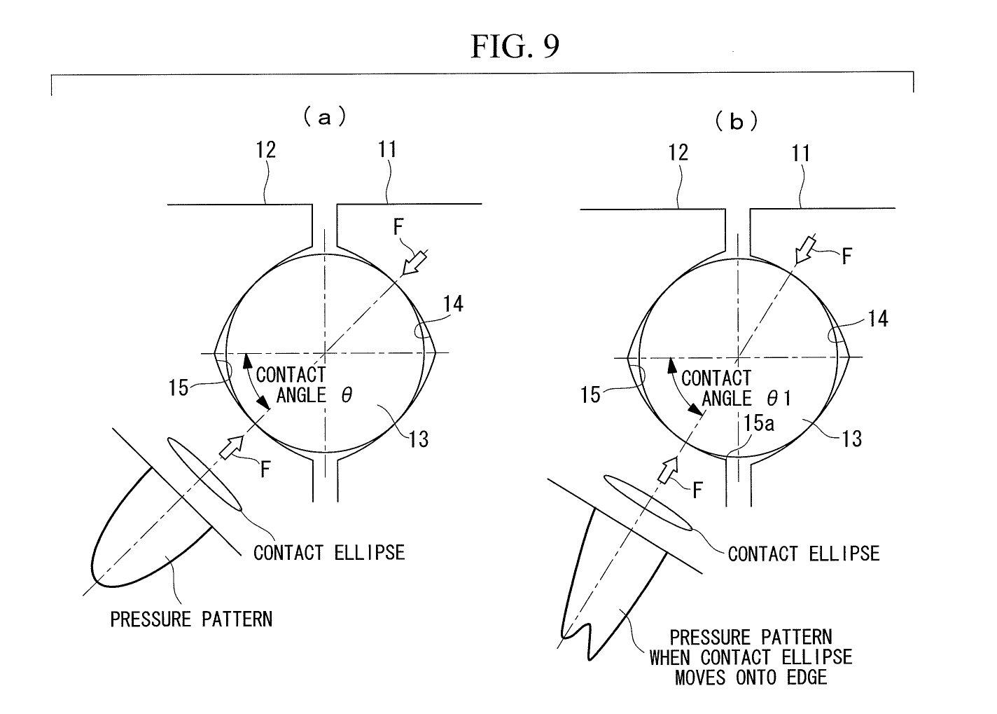

FIG. 9 is a diagram for describing a problem caused by a usual initial contact angle, wherein (a) depicts a contact ellipse and a pressure pattern in a normal state and (b) depicts a contact ellipse and a pressure pattern in a state under effects of structural deformation;

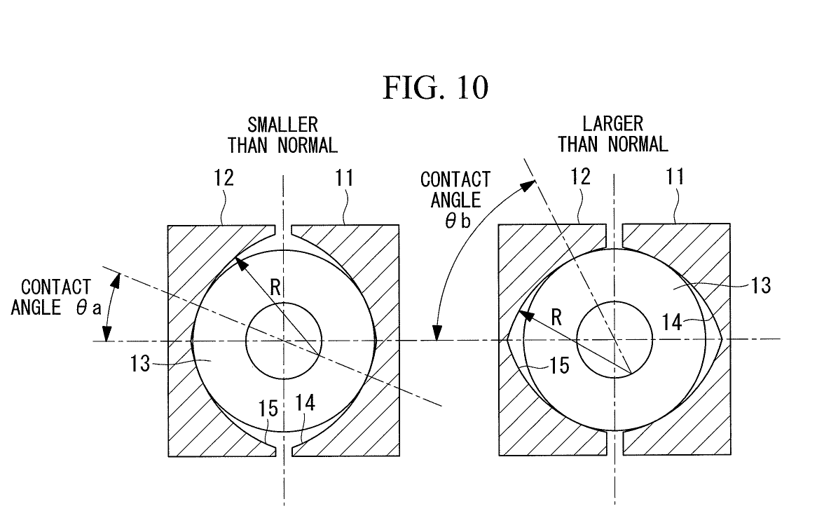

FIG. 10 is a diagram depicting a second embodiment of the slewing bearing structure in accordance with the present invention, and describes a sample configuration in which an initial contact angle is adapted to change in a circumferential direction;

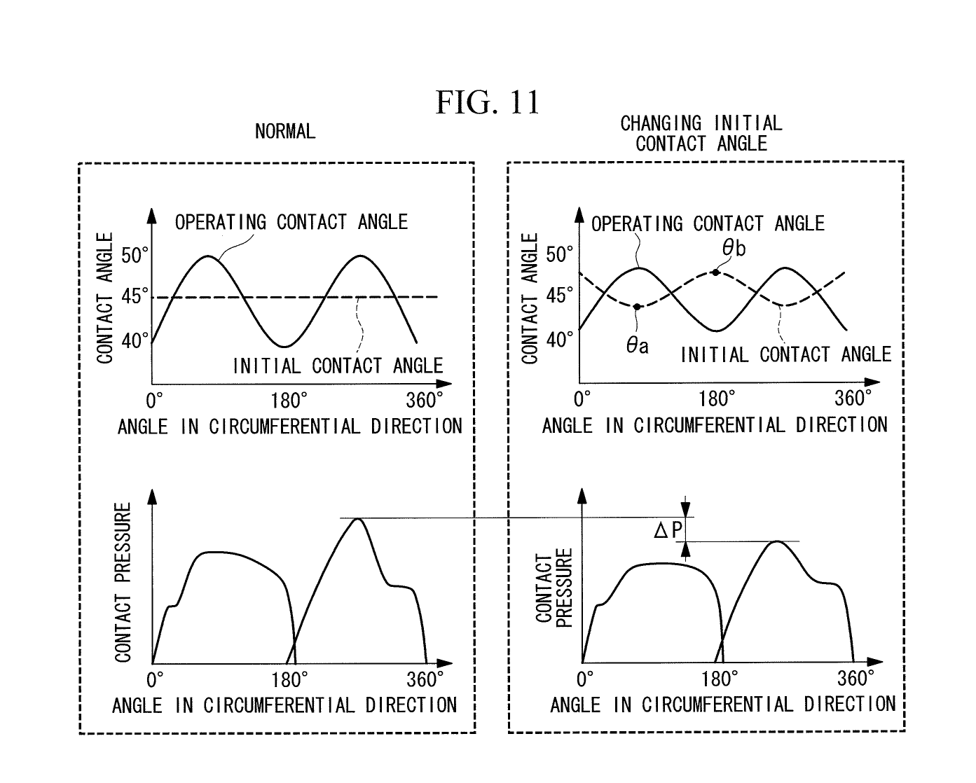

FIG. 11 is an illustrative diagram depicting the effect of suppressing a maximum contact pressure by comparing when an initial contact angle is set as usual and when the initial contact angle is adapted to change in a circumferential direction;

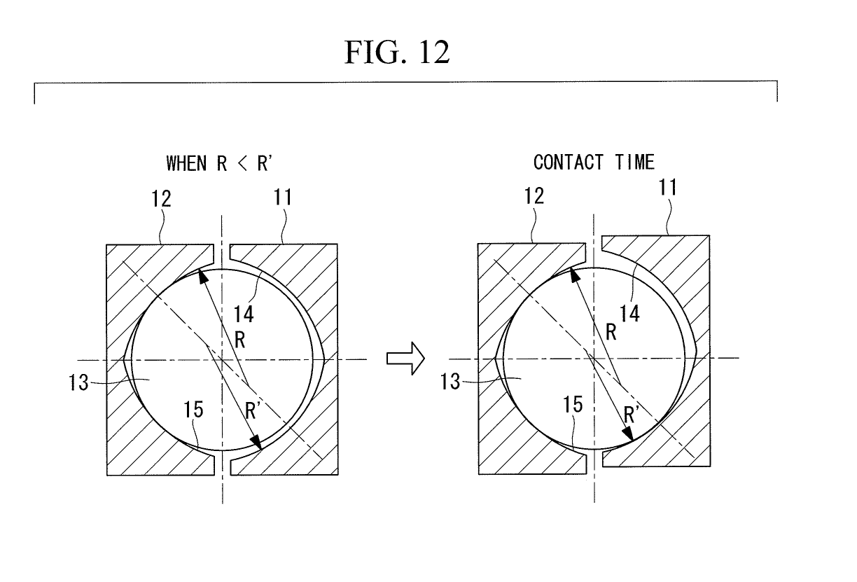

FIG. 12 is a diagram depicting a third embodiment of the slewing bearing structure in accordance with the present invention, and describes a sample configuration in which a groove curvature is adapted to change in a circumferential direction;

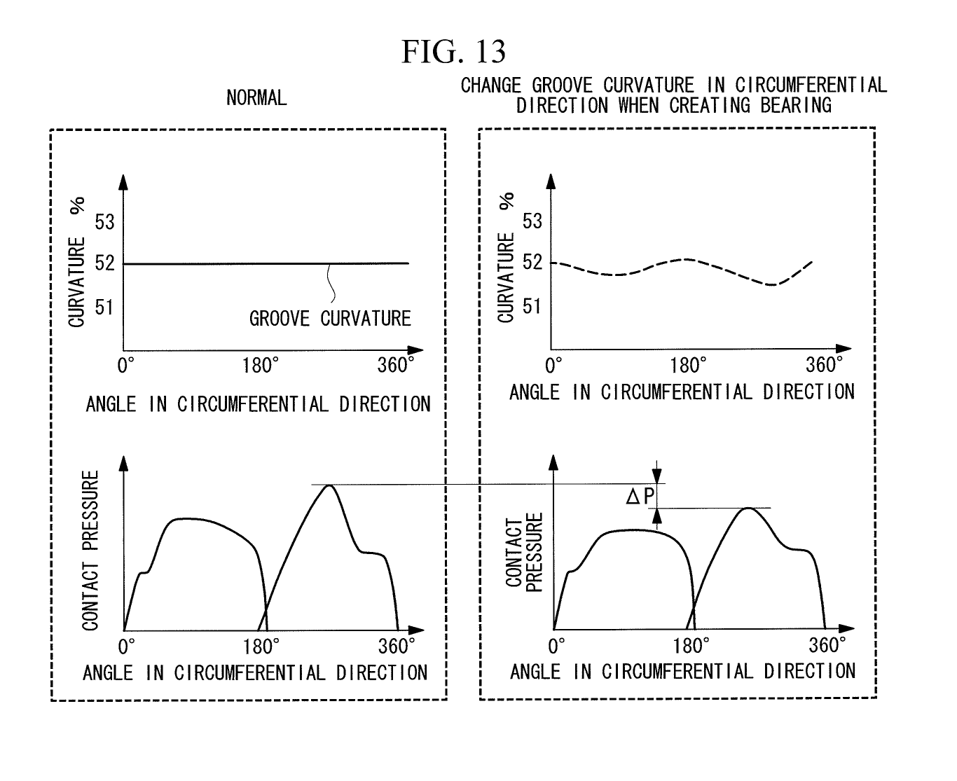

FIG. 13 is an illustrative diagram depicting the effect of suppressing a maximum contact pressure by comparing when the groove curvature is set as usual and when the groove curvature is adapted to change in a circumferential direction;

FIG. 14 is a perspective view describing the outline of a wind turbine apparatus;

FIG. 15 is an illustrative diagram depicting a conventional slewing bearing (or rolling bearing) structure and a method of ensuring rigidity by altering a physical size;

FIG. 16 is a diagram depicting the difference of pressure patterns (or contact pressures changing in accordance with an angle in a circumferential direction) between when structural deformation exists and when structural deformation does not exist; and

FIG. 17 depicts examples of structural deformation when an external force is acting on a slewing ring, wherein (a) depicts an example where an external force deforms an inner ring and an outer ring into an oval shape, (b) depicts an example where an external force bends the inner ring and the outer ring in an axial direction, and (c) depicts an example where an external force causes deformation in a direction where a space between the inner ring and the outer ring is broadened.

### DETAILED DESCRIPTION OF THE INVENTION

One embodiment of a slewing bearing structure in accordance with the present invention will now be described on the basis of the accompanying drawings.

A slewing bearing structure in accordance with the present invention is a rolling bearing applied to a yaw drive unit and a pitch drive unit in a wind turbine apparatus 1 shown in FIG. 14, for example. A rolling bearing is a mechanical element having a configuration in which a bearing ring having a substantially semicircular cross-sectional shape is formed on each of confronting surfaces of an inner ring and an outer ring, and a rolling element such as a ball is put between the bearing rings.

A yaw drive unit of the wind turbine apparatus 1 is an apparatus which slews a nacelle 3 at a top of a tower 2 in accordance with a wind direction so as to receive wind on a front face of a rotor head 4. That is, in the yaw drive unit, a slewing bearing disposed between a top end of the tower 2 and a bottom surface of the nacelle 3 supports the nacelle 3 at the top of the tower 2 so that the nacelle 3 can be slewed in a yaw direction. In this case, an upper side and a lower side of the slewing bearing correspond to the nacelle 3 and the tower 2, respectively. Thus, vertical and horizontal directions of the slewing bearing correspond to axial and radial directions, respectively.

A pitch drive unit of the wind turbine apparatus 1 is an apparatus which slews a wind turbine blade 5 against the rotor head 4 so as to adjust a pitch angle of each of the wind turbine blades 5 attached to the rotor head 4 in accordance with a change in wind speed or the like. Thus, in the pitch drive unit, the slewing bearing disposed between a root (or lower end) of the wind turbine blade 5 and the rotor head 4 supports the wind turbine blade 5 so that the wind turbine blade 5 can be slewed against the rotor head 4 (or a pitch angle of the wind turbine blade 5 can be adjusted). In this case, an upper side and a lower side of the slewing bearing correspond to a distal end side of the wind turbine blade 5 and a root side of the wind turbine blade 5 (or a side of the rotor head 4), respectively. Thus, vertical and horizontal directions of the slewing bearing correspond to axial and radial directions, respectively.

### First Embodiment

A slewing bearing 10A of an embodiment shown in FIG. 1 is a rolling bearing in which bearing rings 14 and 15 are formed on an inner ring 11 and an outer ring 12A, respectively, and rolling elements 13 are put between the confronting bearing rings 14 and 15. The illustrated slewing bearing 10A has a configuration in which two pairs of the bearing rings 14 and 15 are formed in a vertical direction and the rolling elements 13 are arranged in two levels, but the present invention is not limited to this configuration.

In the slewing bearing 10A of the present embodiment, a rigidity strengthening portion 20A, at which rigidity of the outer ring is increased more than at the peripheral portions, is formed at a circumferential area where a bearing contact pressure is high. A pattern of bearing contact pressures can be calculated in advance.

The illustrated rigidity strengthening portion 20A is a wide area created by altering an outer diameter of the outer ring 12A in out-of-round fashion to extend in an outward direction. That is, the rigidity strengthening portion 20A of the outer ring 12A is an area where an outer ring width ta in a horizontal direction (line A-A) is larger than an outer ring width tb in a vertical direction (ta>tb). In other words, the outer ring 12A has a shape, in a planar view, in which an outer ring width gradually changes from the outer ring width ta, the maximum value, at a portion in a horizontal direction where a bearing contact pressure is high to the outer ring width tb, the minimum value, at a portion in a vertical direction where a bearing contact pressure is low.

According to the configuration of the slewing bearing 10A, since the rigidity strengthening portion 20A, at which rigidity of the outer ring 12A is increased more than that at peripheral portions, is provided at an area in a circumferential direction where a bearing contact pressure is high, the rigidity of the outer ring 12A in which the rigidity strengthening portion 20A is provided changes in a circumferential direction so as to become higher at an area where a bearing contact pressure is high. Since such improvement of the rigidity of the outer ring 12A also improves the rigidity of the slewing bearing 10A as a whole, distortion of a pressure pattern can be eliminated while minimizing the increase in weight, enabling to achieve a substantially uniform pressure pattern across the whole circumference.

That is, the rigidity strengthening portion 20A of the outer ring 12A partially increases the rigidity of the outer ring 12A at a circumferential area where a bearing contact pressure is high and deformation can easily occur. The rigidity strengthening portion 20A, which causes the increase in weight, is not formed at a circumferential area having enough rigidity. Thus, the slewing bearing 10A of the present embodiment is capable of uniformizing a pressure pattern to maintain bearing performance while suppressing the whole weight thereof.

Even though the rigidity strengthening portion 20A of the slewing bearing 10A is formed by adopting the broader outer ring width to in a horizontal direction, a circumferential area at which the rigidity strengthening portion 20A is formed can, of course, be changed as needed in accordance with an area of a bearing contact pressure.

A slewing bearing 10B shown in FIG. 2 is a first modification of the present embodiment in which a rigidity strengthening portion 20B is formed on an inner ring 11A, instead of the above-described rigidity strengthening portion 20A of the outer ring 12A. Like numerals indicate like elements to skip detailed description.

The illustrated rigidity strengthening portion 20B is a wide area created by altering an inner diameter of the inner ring 11A in out-of-round fashion to extend in an inward direction. That is, the rigidity strengthening portion 20B of the inner ring 11A is an area where an inner ring width in a horizontal direction (line B-B) is larger than that in a vertical direction. In other words, the inner ring 11A has a shape, in a planar view, in which an inner ring width gradually changes from a portion in a horizontal direction at which a bearing contact pressure is high and the inner ring width becomes maximum to a portion in a vertical direction at which a bearing contact pressure is low and the inner ring width becomes minimum.

According to the configuration of the slewing bearing 10B, since the rigidity strengthening portion 20B, at which rigidity of the inner ring 11A is increased more than that at peripheral portions, is provided at an area in a circumferential direction where a bearing contact pressure is high, the rigidity of the inner ring 11A in which the rigidity strengthening portion 20B is provided changes in a circumferential direction so as to become higher at an area where a bearing contact pressure is high. Since such improvement of the rigidity of the inner ring 11A also improves the rigidity of the slewing bearing 10B as a whole, as with the case in the above-described embodiment, distortion of a pressure pattern can be eliminated while minimizing the increase in weight, enabling to achieve a substantially uniform pressure pattern across the whole circumference.

The rigidity strengthening portion 20B of the inner ring 11A and the rigidity strengthening portion 20A of the outer ring 12A described above may be adopted not only separately but also in combination.

Also, even though the above-described embodiment and the first modification includes the rigidity strengthening portions 20A and 20B having a rectangular cross-sectional surface, rigidity strengthening portions 20C and 20D having a trapezoidal cross-sectional surface may be adopted, for example, as with second and third modifications shown in FIGS. 3 and 4, respectively.

In the second modification shown in FIG. 3, the rigidity strengthening portion 20C, which corresponds to the rigidity strengthening portion 20A of the outer ring 12A shown in FIG. 1, has a trapezoidal cross-sectional shape in which a side on a top surface to receive a bearing contact pressure is longer than a side on a bottom surface in parallel with the top surface, as shown by a cross-sectional surface of a slewing bearing 100 in an axial direction. That is, the rigidity strengthening portion 20C is a portion which creates a wide area on an outer ring 12A′ and has an outer periphery slanting toward an inner periphery thereof in a downward direction.

In the third modification shown in FIG. 4, the rigidity strengthening portion 20D, which corresponds to the rigidity strengthening portion 20B of the inner ring 11A shown in FIG. 2, has a trapezoidal cross-sectional shape in which a side on a top surface to receive a bearing contact pressure is longer than a side on a bottom surface in parallel with the top surface, as shown by a cross-sectional surface of a slewing bearing 10D in an axial direction. That is, the rigidity strengthening portion 20D is a portion which creates a wide area on an inner ring 11A′ and has an inner periphery slanting toward an outer periphery thereof in a downward direction.

As described above, since the rigidity strengthening portions 20C and 20D have, at a wide portion, a trapezoidal cross-sectional shape in which a side on a top surface to receive a bearing contact pressure is longer than a side on a bottom surface in parallel with the top surface, a cross-sectional area and rigidity thereof can be efficiently increased while minimizing the increase in the weight thereof, eliminating distortion of a pressure pattern.

Also, unlike the above-described slewing bearings 10A to 10D of the present embodiment, or instead of the rigidity strengthening portions 20A to 20D forming a wide area, a reinforcing member may be attached.

A slewing bearing 10E of a fourth modification shown in FIG. 5 includes a rigidity strengthening portion 20E which is created by attaching a rib 30 as a reinforcing member to an outer periphery of the outer ring 12. A plurality of ribs 30 are attached by welding or the like to an area of the outer ring 12 in a circumferential direction where a bearing contact pressure is high. The area on the outer periphery to which the ribs 30 are attached substantially corresponds to the wide area of the above-described rigidity strengthening portion 20A. A pitch of attaching the ribs 30 in a circumferential direction may be constant, or altered so as to be smaller at an area of a higher bearing contact pressure.

A slewing bearing 10F of a fifth modification shown in FIG. 6 includes a rigidity strengthening portion 20F which is created by attaching a reinforcing plate 31 as a reinforcing member to an outer periphery of the outer ring 12. The reinforcing plate 31 is attached by welding or the like to an area of the outer ring 12 in a circumferential direction where a bearing contact pressure is high. The area on the outer periphery to which the reinforcing plate 31 is attached substantially corresponds to the wide area of the above-described rigidity strengthening portion 20A.

The thickness of the reinforcing plate 31 may be constant overall as shown in FIGS. 6A and 6B, or a reinforcing plate 31A, which is thicker at a portion corresponding to an area of a higher bearing contact pressure, may be used as shown in FIG. 6C.

The above-described reinforcing members may be partially attached to a top surface side on the outer periphery of the outer ring 12 for increasing rigidity of the top surface which receives a bearing contact pressure, as with a sixth modification shown in FIG. 7. That is, the illustrated sixth modification includes a rigidity strengthening portion 20G which is created by attaching a reinforcing plate 31B to only a substantially upper half portion on the outer periphery of the outer ring 12. The rigidity strengthening portion 20G having the reinforcing plate 31B can provide the same functional effects as the rigidity strengthening portion 20C of the second modification in which the wide area formed on the outer ring 12A′ has a trapezoidal cross-sectional shape (see FIG. 3).

A thickness of the reinforcing plate 31B may be constant or changed so as to be thicker at a portion corresponding to an area of a higher bearing contact pressure. Instead of the reinforcing plate 31B, a rib such as the one shown in the fourth modification (see FIG. 5) may be adopted.

Even though the reinforcing member such as the rib 30 and the reinforcing plates 31, 31A and 31B are attached to the outer periphery of the outer ring 12 in the above-described fourth to sixth modifications, a similar reinforcing member may be attached to the inner periphery of the inner ring 11.

By using these reinforcing members to create the rigidity strengthening portions 20E, 20F and 20G, the rigidity of the inner ring 11 or the outer ring 12 can be changed in accordance with a bearing contact pressure in a circumferential direction, and it is thus possible to eliminate distortion of a pressure pattern while minimizing the increase in weight.

### Second Embodiment

A second embodiment of a clewing bearing structure in accordance with the present invention will now be described on the basis of FIGS. 8 to 11. FIGS. 8 and 9 are diagrams exaggerating a curvature of main elements or the like, and like numerals indicate like elements to skip detailed description.

FIG. 8 shows the spherical rolling element 13 put between the bearing ring 14 of the inner ring 11 and the bearing ring 15 of the outer ring 12 in a normal state in which a contact angle θ is in an appropriate state. In the normal state like this, an initial contact angle, which is 45 degrees from either horizontal or vertical axes, equals the contact angle θ, and four contact locations T are created. A radius of the rolling element 13 is indicated as r, and a curved surface of the bearing rings 14 and 15 is an arc of a radius R.

In the normal state shown in FIG. 8, a ball weight F is acting in a direction at the contact angle θ, which equals an initial contact angle of 45 degrees, as shown in FIG. 9(a), and a contact ellipse and a contact pattern are formed which are symmetric about a line at the contact angle θ.

In a common rolling bearing, an initial contact angle of 45 degrees, shown as a dashed line on the left side in FIG. 11, is adapted to be constant in a circumferential direction, as shown as “Normal” in FIG. 11. The contact angle θ under operation changes as shown by a solid sine curve in FIG. 11, for example, because of a weight condition or structural deformation. Thus, as shown in FIG. 9(b), if the contact angle θ changes greatly to θ1, a contact pressure suddenly increases as the contact ellipse moves onto an edge portion. The edge portion is an end portion 15a of the bearing ring 15.

Thus, in the present embodiment, which relates to a rolling bearing in which the rolling element 13 is put between the bearing rings 14 and 15 formed on the inner ring 11 and the outer ring 12, an initial contact angle, at which the rolling element 13 contacts with a surface of the bearing rings 14 and 15 under no load, is adapted to change in a circumferential direction so that the maximum contact pressure under weight load and structural deformation is decreased. That is, as shown in FIG. 10 and on the right of FIG. 11 titled as “CHANGING INITIAL CONTACT ANGLE”, the initial contact angle shown by a dashed line is adapted to change in a circumferential direction so as to be an opposite phase sine curve of a solid sine curve indicating an operating contact angle.

In this case, as shown in FIG. 10, a lower peak θa and a higher peak θb of the initial contact angle shown by a dashed line is lower or higher than a normal initial contact angle of 45 degrees, respectively.

According to such a clewing bearing structure, since an initial contact angle, at which the rolling element 13 contacts with a surface of the bearing rings 14 and 15 under no load, is adapted to change in a circumferential direction so that the maximum contact pressure under weight load and structural deformation is decreased, the contact angle θ does not change greatly under weight load and structural deformation, enabling to prevent sudden increase of a contact pressure which happens when a contact ellipse moves onto an edge portion. That is, since the initial contact angle is preliminarily set to be small at an angle in a circumferential direction where an operating contact angle is large while being set to be large at an angle in a circumferential direction where an operating contact angle is small, the contact angle θ, which changes under load, can be prevented from changing to a value far from a normal initial contact angle of 45 degrees.

By suppressing the change of the contact angle θ under weight load and structural deformation as described above, it is possible to prevent a contact ellipse from moving onto an edge portion due to the change of the contact angle θ to sharply increase a contact pressure. That is, since an initial contact angle, which used to be constant in a circumferential direction, is adapted to change in a circumferential direction so that the maximum contact pressure under weight load and structural deformation is decreased, the contact ellipse does not move onto an edge portion even under operating load, and it is thus possible to suppress the change of the contact angle θ and prevent sudden increase of the contact pressure. Specifically, as shown in FIG. 11, since the change of the operating contact angle is decreased, or the operating contact angle gets closer to a normal initial contact angle of 45 degrees, the maximum value of the contact pressure decreases for the amount of ΔP.

### Third Embodiment

A third embodiment of a clewing bearing structure in accordance with the present invention will now be described on the basis of FIGS. 8, 12 and 13. FIG. 12 is a diagram exaggerating a curvature of main elements or the like, and like numerals indicate like elements to skip detailed description.

An inner bearing contact pressure of a plain bearing changes on the basis of a diameter of the rolling element 13 and a groove radius of the bearing rings 14 and 15, or a ratio of a radius r of the rolling element 13 and a groove radius R of an arc constituting the bearing rings 14 and 15 (a groove curvature=R/2r). Specifically, if the groove curvature gets closer to 50% and a diameter 2r of the rolling element 13 and the groove radius R get closer to each other, a contact pressure becomes smaller.

But if the diameter of the rolling element 13 and the groove radius R get closer to each other, a contact area of the rolling element 13 increases, causing a bearing torque (a force needed to rotate a bearing) of the plain bearing to grow and power loss caused by heat generation to increase.

Thus, in a slewing bearing structure of the present embodiment, the groove radius R of the bearing rings 14 and 15, which are formed on the inner ring 12 and outer ring 13 of a rolling bearing to support the rolling element 13, is adapted to change in a circumferential direction so that the maximum contact pressure under weight load and structural deformation is decreased, as shown in FIG. 12, for example. That is, in the present embodiment, the groove radius R, which is usually constant in a circumferential direction, is preliminarily adapted to change in a circumferential direction so that the maximum contact pressure is decreased.

As shown in a concrete example in FIG. 12, at a cross-sectional portion where the groove radius R of the bearing ring 15 is smaller than a groove radius R′ of the bearing ring (R<R′), the rolling element 13 does not contact with the bearing ring 14 of the inner ring 11 in a non-contact time. But in a contact time, the rolling element 13 contacts with the bearing ring 14 of the inner ring 11 because the inner ring 11 moves or deforms under operating load. As a result, as shown in FIG. 13, the maximum value of a contact pressure is decreased for the amount of ΔP because a groove curvature, which is constant in a normal time, is adapted to change in a circumferential direction when creating a bearing.

According to the slewing bearing structure of the present embodiment, since the groove radius of the bearing rings 14 and 15 are adapted to change in a circumferential direction so that the maximum contact pressure under weight load and structural deformation is decreased, the contact pressure at a portion where the maximum contact pressure occurs can be suppressed while minimizing the increase in a bearing torque. That is, the groove radius R of the bearing rings 14 and 15, which used to be constant in a circumferential direction, is adapted to change in a circumferential direction so that the maximum contact pressure under weight load and structural deformation is decreased, a groove curvature, which is a relationship (or ratio) of the diameter of the rolling element 13 and the groove radius of the bearing rings 14 and 15, is optimized under operating load, enabling to suppress the maximum contact pressure and the bearing torque.

As described above, according to a slewing bearing structure of each of the above-described embodiments, by adjusting and changing the rigidity of a rolling bearing while minimizing the increase in the weight thereof, it is possible to prevent distortion of a pressure pattern caused by structural deformation from unfavorably affecting bearing performance to maintain favorable bearing performance.

Also, by changing and optimizing as needed an initial contact angle and a groove radius of a bearing ring in a circumferential direction, it is possible to prevent sudden increase of a contact pressure or suppress the maximum contact pressure and a bearing torque.

As a result, the maximum value of the contact pressure can be suppressed to increase a serviceability limit of a rolling bearing compared with the one having a same size.

By adopting the above-described rolling bearing as a slewing bearing of a yaw drive unit or a pitch drive unit of the wind turbine apparatus 1, the weight of a structure on top of the tower 2 can be decreased to mitigate weight load.

The present invention is not limited to the above-described embodiments, and may be altered as need without departing from the essence thereof.

What is claimed is:

1. A slewing bearing structure of a rolling bearing in which a rolling element is put between bearing rings formed on an inner ring and an outer ring, wherein
a rigidity strengthening portion, at which rigidity of the inner ring and/or the outer ring is increased more than that at peripheral portions, is formed at a circumferential area where a bearing contact pressure is high.

2. The slewing bearing structure of claim 1, wherein the rigidity strengthening portion is a wide portion created by altering an inner diameter of the inner ring and/or an outer diameter of the outer ring in out-of-round fashion.

3. The slewing bearing structure of claim 2, wherein the wide portion has a trapezoidal cross-sectional shape in an axial direction.

4. The slewing bearing structure of claim 1, wherein the rigidity strengthening portion provides a reinforcing member attached to an outer periphery of the outer ring and/or an inner periphery of the inner ring.

5. A slewing bearing structure of a rolling bearing in which a rolling element is put between bearing rings formed on an inner ring and an outer ring, wherein
an initial contact angle, at which the rolling element contacts with a surface of the bearing rings under no load, is adapted to change in a circumferential direction so that a maximum contact pressure under weight load and structural deformation is decreased.

6. A slewing bearing structure of a rolling bearing in which a rolling element is put between bearing rings formed on an inner ring and an outer ring, wherein
a groove radius of the bearing rings is adapted to change in a circumferential direction so that a maximum contact pressure under weight load and structural deformation is decreased.
